(19) United States
(12) Patent Application Publication
(10) Pub. No.: US 2019/0327263 A1
(43) Pub. Date: Oct. 24, 2019

(54) DISTRIBUTED CLIENT PROTECTION

(71) Applicant: Forcepoint LLC, Austin, TX (US)

(72) Inventors: Christian JALIO, Helsinki (FI); Valtteri RAHKONEN, Helsinki (FI); Antti LEVOMÄKI, Helsinki (FI)

(73) Assignee: Forcepoint LLC, Austin, TX (US)

(21) Appl. No.: 15/956,357

(22) Filed: Apr. 18, 2018

(51) Int. Cl. H04L 29/06; H04L 12/26; G06F 21/56

(52) U.S. Cl. CPC H04L 63/1466; G06F 21/567; H04L 63/20; H04L 43/062

(57) ABSTRACT

A method, system, and computer-usable medium are disclosed for, responsive to receipt of traffic from a server to a client, parsing content of the traffic, and injecting additional content into original content of the server response to override an action of the original content, such that when the client executes the content of the traffic the client determines whether the content includes additional content that overrides the action of the original content, and in response to determining that the content includes additional content that overrides the action of the original content, communicates parameters associated with execution of the action to an inspection service to determine if the action is malicious.

### FIELD OF DISCLOSURE

The present invention relates in general to the field of computers and similar technologies, and in particular to software utilized in this field. Still more particularly, it relates to a method, system, and computer-usable medium for performing distributed protection for a client information handling system with respect to network traffic.

### BACKGROUND

While network communication among networked computers, including the use of the Internet, has many advantages, one downside to network communication is that it may render networked computers susceptible to malicious attacks from viruses or other intrusions. For example, one common attack on client computing systems is to use a script embedded in network traffic that appears as legitimate-looking, non-malicious content, such as embedding of a malicious JavaScript or Visual Basic script into Hypertext Transfer Protocol (HTTP) pages or electronic mails.

Such script-based attacks may be difficult to detect, as they may be very effectively obfuscated and/or split into multiple files to avoid detection, or may themselves be programmed to generate some other malicious script that may be executed by a client device.

Using existing approaches to avoid malware intrusion, a network security device may be configured to, every time a new obfuscation of malicious code is used, update the detection engines of the security device to identify such obfuscation and its associated malicious content. In addition, in situations in which a parser of a network security device was capable of detecting malicious content, the malicious content may be spread over multiple files sent over multiple connections, so a security device may have difficulty in identifying the multiple files as related and thus fail to inspect the multiple files as one.

As a result of obfuscations, typically the best detection method for these types of malicious attacks have been for security devices to actually execute the content in a “sandbox” environment and detecting the malicious activity performed within the sandbox. However, use of a sandbox may not offer complete protection, as malware authors have created malicious code that attempts to detect use of a sandbox and then not performing malicious action in their script if a sandbox is detected.

This had led to a situation in which detection may be unreliable in addition to taking significant time and computational resources to parse and emulate files or actually execute the files as they would be in a client, and such existing techniques may cause significant delay preventing network traffic from being used in real time. Thus, typically security devices operate in a “detect-only” mode in which they issue alerts when malicious activity is detected and push reputation as malicious content in order to block future attacks. However, such approach may work well for a single code example, but future permutations of the malicious code may go undetected at least once again assuming it is even detected at all.

### SUMMARY

In accordance with the teachings of the present disclosure, certain disadvantages and problems associated with existing approaches to network and data security have been reduced or eliminated.

In accordance with embodiments of the present disclosure, a computer-implementable method for managing network communication may include, responsive to receipt of traffic from a server to a client, parsing content of the traffic, and injecting additional content into original content of the server response to override an action of the original content, such that when the client executes the content of the traffic the client determines whether the content includes additional content that overrides the action of the original content, and in response to determining that the content includes additional content that overrides the action of the original content, communicates parameters associated with execution of the action to an inspection service to determine if the action is malicious.

In accordance with these and other embodiments of the present disclosure, a system may include a processor, a data bus coupled to the processor, and a non-transitory, computer-readable storage medium embodying computer program code, the non-transitory, computer-readable storage medium being coupled to the data bus, the computer program code interacting with a plurality of computer operations and comprising instructions executable by the processor. The instructions may be configured for, responsive to receipt of traffic from a server to a client, parsing content of the traffic, and injecting additional content into original content of the server response to override an action of the original content, such that when the client executes the content of the traffic the client determines whether the content includes additional content that overrides the action of the original content, and in response to determining that the content includes additional content that overrides the action of the original content, communicates parameters associated with execution of the action to an inspection service to determine if the action is malicious.

In accordance with these and other embodiments of the present disclosure, a non-transitory, computer-readable storage medium may embody computer program code, the computer program code comprising computer executable instructions configured for, responsive to receipt of traffic from a server to a client, parsing content of the traffic, and injecting additional content into original content of the server response to override an action of the original content, such that when the client executes the content of the traffic the client determines whether the content includes additional content that overrides the action of the original content, and in response to determining that the content includes additional content that overrides the action of the original content, communicates parameters associated with execution of the action to an inspection service to determine if the action is malicious.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are explanatory examples and are not restrictive of the claims set forth in this disclosure.

### BRIEF DESCRIPTION OF THE DRAWINGS

A more complete understanding of the example, present embodiments and certain advantages thereof may be acquired by referring to the following description taken in conjunction with the accompanying drawings, in which like reference numbers indicate like features, and wherein:

FIG. 1 illustrates an example information handling system in which the methods and systems disclosed herein may be implemented, in accordance with embodiments of the present disclosure;

FIG. 2 illustrates a block diagram of a system for performing distributed client protection, in accordance with embodiments of the present disclosure;

FIG. 3 illustrates a flow chart of an example method for performing distributed client protection in a protection mode, in accordance with embodiments of the present disclosure; and

FIG. 4 illustrates a flow chart of an example method for performing distributed client protection in a monitoring mode, in accordance with embodiments of the present disclosure.

### DETAILED DESCRIPTION

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a mobile device such as a tablet or smartphone, a consumer electronic device, a connected “smart device,” a network appliance, a network storage device, a network gateway device, a server or collection of servers or any other suitable device and may vary in size, shape, performance, functionality, and price. The information handling system may include volatile and/or non-volatile memory, and one or more processing resources such as a central processing unit (CPU) or hardware or software control logic. Additional components of the information handling system may include one or more storage systems, one or more wired or wireless interfaces for communicating with other networked devices, external devices, and various input and output (I/O) devices, such as a keyboard, a mouse, a microphone, speakers, a track pad, a touchscreen and a display device (including a touch sensitive display device). The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or solid state drive), a sequential access storage device (e.g., a tape disk drive), optical storage device, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

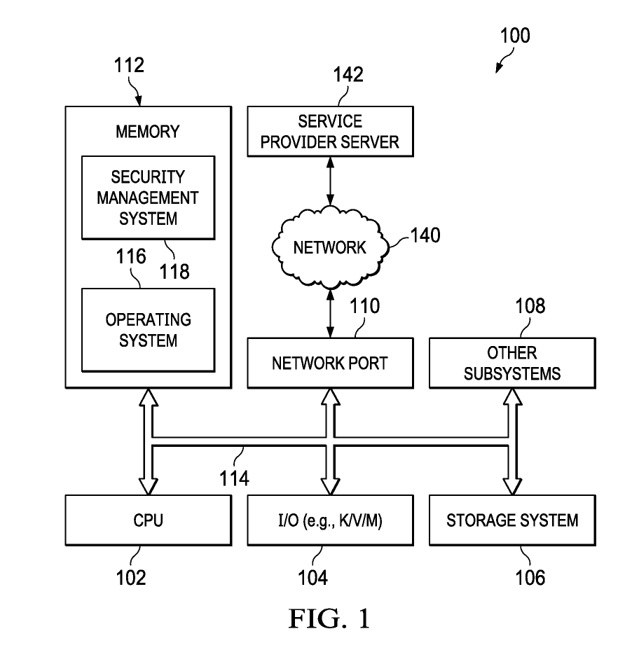

FIG. 1 illustrates an example information handling system 100 in which the methods and systems disclosed herein may be implemented, in accordance with embodiments of the present disclosure. Information handling system 100 may include a processor (e.g., central processor unit or “CPU”) 102, input/output (I/O) devices 104 (e.g., a display, a keyboard, a mouse, and/or associated controllers), a storage system 106, and various other subsystems 108. In various embodiments, information handling system 100 may also include network port 110 operable to couple to a network 140, which may likewise be accessible by a service provider server 142. Information handling system 100 may also include system memory 112, which may be coupled to the foregoing via one or more buses 114. System memory 112 may store operating system (OS) 116 and in various embodiments may also include a security management system 118. In some embodiments, information handling system 100 may be able to download security management system 118 from service provider server 142. In other embodiments, security management system 118 may be provided as a service from the service provider server 142.

In various embodiments, security management system 118 may be configured to enable distributed client protection of networked client devices by implementing script engines that allow for overriding functions and actions for a specific purpose (e.g., content inspection). Such override capability may make it possible for a security device to override actions described in content, such as overriding a JavaScript evaluation action to perform some other operations before actually calling the real JavaScript engine evaluation function. The overridden function may receive content with obfuscations removed and it may communicate the action to an inspection engine (e.g., internal to the security device or a cloud-based inspection engine external to the security device), and the inspection engine may perform an analysis of the function's parameters. Thus, no matter how many layers of the obfuscation content of network traffic may have, the inspection engine may receive the un-obfuscated code layer by layer until a final executed script is sent to the inspection engine and the last layer of the actual original malicious content is inspected without obfuscations. Using such systems and methods, a gateway security device may not require a large amount of resources because the actual parsing and removal of obfuscation layers may be performed in the client endpoint and the client endpoint may communicate content to an inspection engine and await a security decision from an inspection decision. In case of a detect-only mode, a client may immediately execute code in order to minimize the delay associated with inspection, while in protection mode the client may wait for the inspection engine to respond and, if applicable, block the execution of the content.

Security management system 118 may override content within network traffic by injecting additional scripting into the original content, for example by adding code to an HTML document communicated to a client endpoint device or adding code to a script attachment of an electronic mail. Accordingly, no additional security program is required to be installed to the client endpoint device which received the content.

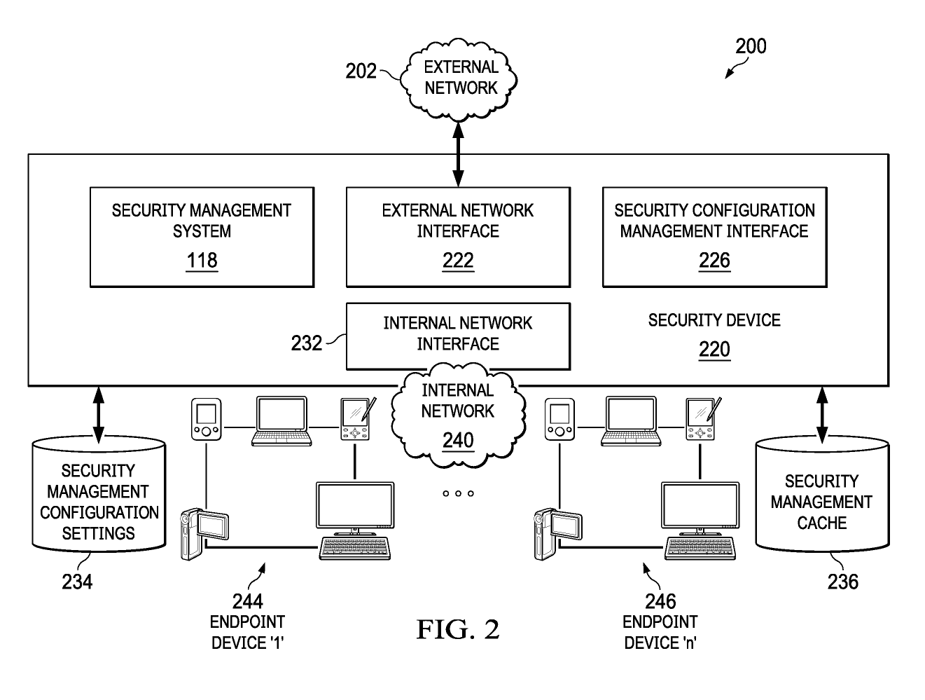

In a protection mode, content inspection may be performed in the security management system 118 (e.g., gateway) itself or performed by a cloud service (e.g., a cloud service coupled to external network 202 shown in FIG. 2, described in greater detail below). When inspection is performed by a cloud service, content reputation may be shared throughout a system of networked devices or some sort of cloud-based telemetry could be enabled. However, local inspection by the security management system 118 itself may provide for lower latency when operating in a protection mode.

In some embodiments, communication between the inspection service, whether local or cloud-based) may be encrypted for more robust security. Such encryption may be achieved by using a services public key for encryption (e.g., only the inspection service could decrypt a stream of content) or by using normal Transport Layer Security (TLS) encryption. Using either encryption approach, it may be possible to include a trust of the inspection service to the injected content, such as an inspection services public key or pin to the inspection service certificate, and also add client specific identifiers to pass back to the inspection service for reliably connecting the inspection of specified content to some connection or content seen originally in the gateway.

In some embodiments, security management system 118 and the functionality thereof may improve processor efficiency, and thus the efficiency of information handling system 100, by performing network security operations with greater efficiency and with decreased processing resources as compared to existing approaches for similar network security operations. In these and other embodiments, security management system 118 and the functionality thereof may improve effectiveness in ensuring network security, and thus the effectiveness of information handling system 100, by performing network security operations with greater effectiveness to existing approaches for similar network security operations. As will be appreciated, once information handling system 100 is configured to perform the functionality of security management system 118, information handling system 100 becomes a specialized computing device specifically configured to perform the functionality of security management system 118, and is not a general purpose computing device. Moreover, the implementation of functionality of security management system 118 on information handling system 100 improves the functionality of information handling system 100 and provides a useful and concrete result of improving network security and performing network security operations with greater efficiency and with decreased processing resources by enabling distributed client protection of networked client devices as described herein.

FIG. 2 illustrates a block diagram of a system 200 for performing distributed client protection, in accordance with embodiments of the present disclosure. In some embodiments, a security device 220 may include an external network interface 222, a security configuration management interface 226, an internal network interface 232, and a security management system 118. Security device 220 may be implemented using any suitable information handling system 100, including without limitation a gateway, a firewall, an intrusion prevention system, an intrusion detection system, or any other suitable security device capable of implementing security management system 118. In some embodiments, security device 220 may be implemented as an individual security device 220, a virtual context security device 220, or a security device 220 cluster.

Security device 220 may also include in some embodiments a repository of security management configuration settings 234 and a security management cache 236. In certain embodiments, security configuration management interface 226 may be implemented to receive instructions relating to network security policy decisions from security management system 118.

Skilled practitioners of the art will be familiar with network communication involving communicating Internet Protocol (IP) datagrams, or packets, to a target group of recipient network addresses in real-time or near real-time. In some embodiments, the target group recipient network addresses may be respectively associated with a corresponding endpoint device ‘1’ 244 through ‘n’ 246. As used herein, an endpoint device refers to an information processing system such as a personal computer, a laptop computer, a tablet computer a smart phone, a mobile telephone, a digital camera, a video camera, or other device capable of storing, processing and communicating data via a network, such as an internal network 240 interfaced to internal network interface 232. In various embodiments, the communication of the data may take place in real-time or near-real-time.

Embodiments of the invention may reflect an appreciation that network communication may represent an efficient means for communicating useful information. However, those of skill in the art will likewise appreciate that it may be desirable to secure such network communication to prevent malicious attacks on network components. Many existing solutions for providing security in a network environment have disadvantages, as described in the Background section of this application. However, security management system 118 as disclosed herein may overcome these disadvantages by implementing script engines that allow for overriding functions and actions for a specific purpose (e.g., content inspection), as described herein.

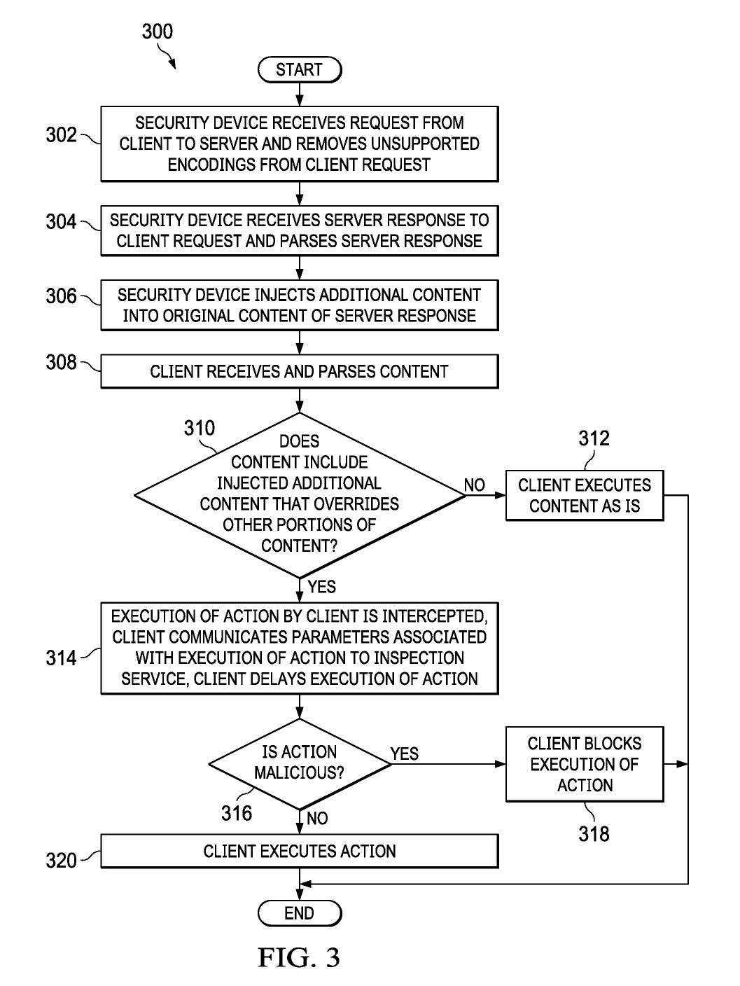

FIG. 3 illustrates a flow chart of an example method 300 for performing distributed client protection in a protection mode of operation, in accordance with embodiments of the present disclosure. According to some embodiments, method 300 may begin at step 302. As noted above, teachings of the present disclosure may be implemented in a variety of configurations of information handling system 100. As such, the preferred initialization point for method 300 and the order of the steps comprising method 300 may depend on the implementation chosen.

At step 302, a security device (e.g., security device 220, a gateway, etc.) may receive a request from a client (e.g., an endpoint device 244, 246) to a server (e.g., a server coupled to external network 202) for network traffic from the server and remove unsupported encodings from the client request in order to prevent a server from using such encodings in its response. At step 304, the security device may receive a server response to the client request and parse the server response.

At step 306, the security device may inject additional content into the original content of the server response, thereby overriding certain actions of the original content. With non-encoded content, the security device may inject the additional content where appropriate (e.g., in an HTML head element in an HTML file, at the beginning of a script file attached to an electronic mail, etc.) in the original content to override the original content. With encoded content, the security device must understand the encoding. Accordingly, with encoded content, the security device may decode the content, then produce new encoded content to be sent to the client. Thus, the security device may inject the additional content where appropriate (e.g., in an HTML head element in an HTML file, at the beginning of a script file attached to an electronic mail, etc.) in the decoded original content to override the original content, and then re-encode the modified decoded content which is sent to the client.

At step 308, the client may receive the content and parse the content. At step 310, the client may determine if the content includes any injected additional content that overrides other portions (e.g., original content) of the content. If the client determines that the content does not include any injected additional content that overrides other portions of the content, then method 300 may proceed to step 312. Otherwise, if the client determines that the content does include injected additional content that overrides other portions of the content, then method 300 may proceed to step 314.

At step 312, the client may execute the content as is. After completion of step 312, method 300 may end.

At step 314, if the content includes an action in which the injected additional content is interested (e.g., a JavaScript evaluation function), the execution of such action by the client may be intercepted, and the client may, in accordance with the injected additional content, communicate parameters associated with execution of the action to an inspection service for inspection of the action. Such inspection service may execute locally on the security device or remotely on a cloud-based inspection service (e.g., coupled to external network 202). During inspection of the action by the inspection service, execution of the action by the client may be delayed pending a response from the inspection service.

At step 316, the client may receive a response from the inspection service and determine from the response whether the action was determined by the inspection service to be malicious. If the action was determined to be malicious, method 300 may proceed to step 318. Otherwise, if the action was determined to not be malicious, method 300 may proceed to step 320.

At step 318, the client may block execution of the action with malicious content. After completion of step 318, method 300 may end.

At step 320, the client may execute the action. After completion of step 320, method 300 may end.

Is noted that in execution of method 300, as the client parses the content and removes obfuscation layers of the content, the remainder of the content may have additional content injected as in step 306, such that each obfuscation layer may be appropriately analyzed and examined for malicious content until the whole content of the network traffic has been processed.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using CPU 102, security management system 118 executing thereon, and/or any other system operable to implement method 300. In certain embodiments, method 300 may be implemented partially or fully in software and/or firmware embodied in computer-readable media.

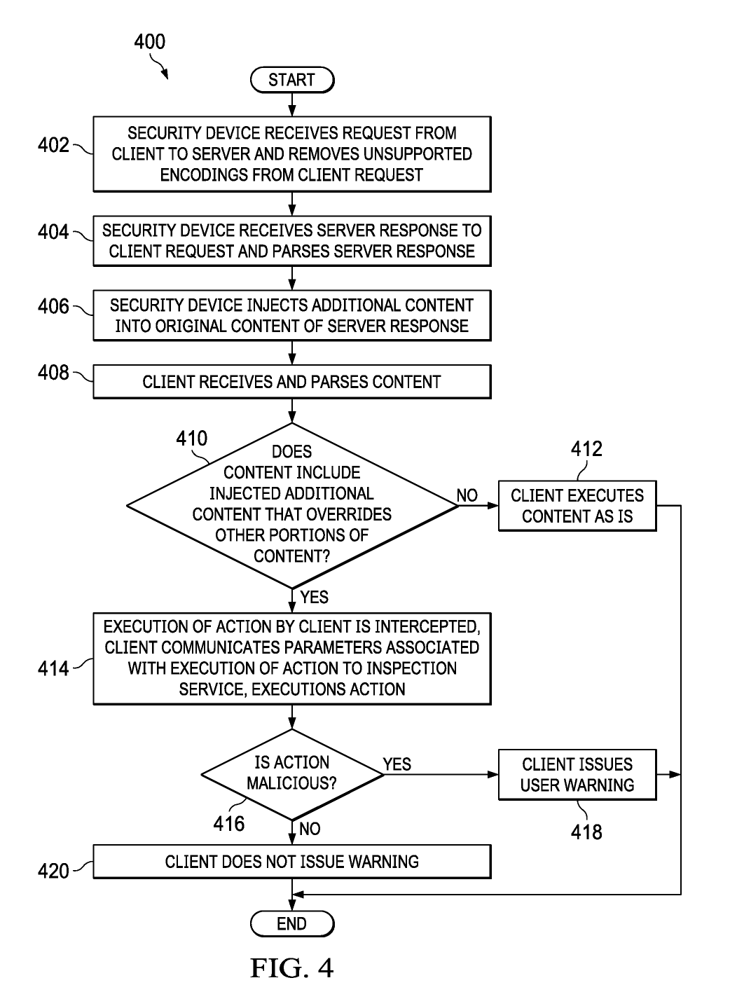

FIG. 4 illustrates a flow chart of an example method 400 for performing distributed client protection in a monitoring mode of operation, in accordance with embodiments of the present disclosure. According to some embodiments, method 400 may begin at step 402. As noted above, teachings of the present disclosure may be implemented in a variety of configurations of information handling system 100. As such, the preferred initialization point for method 400 and the order of the steps comprising method 400 may depend on the implementation chosen.

At step 402, a security device (e.g., security device 220, a gateway, etc.) may receive a request from a client (e.g., an endpoint device 244, 246) to a server (e.g., a server coupled to external network 202) for network traffic from the server and remove unsupported encodings from the client request in order to prevent a server from using such encodings in its response. At step 404, the security device may receive a server response to the client request and parse the server response.

At step 406, the security device may inject additional content into the original content of the server response, thereby overriding certain actions of the original content. With non-encoded content, the security device may inject the additional content where appropriate (e.g., in an HTML head element in an HTML file, at the beginning of a script file attached to an electronic mail, etc.) in the original content to override the original content. With encoded content, the security device must understand the encoding. Accordingly, with encoded content, the security device may decode the content, then produce new encoded content to be sent to the client. Thus, the security device may inject the additional content where appropriate (e.g., in an HTML head element in an HTML file, at the beginning of a script file attached to an electronic mail, etc.) in the decoded original content to override the original content, and then re-encode the modified decoded content which is sent to the client.

At step 408, the client may receive the content and parse the content. At step 410, the client may determine if the content includes any injected additional content that overrides other portions (e.g., original content) of the content. If the client determines that the content does not include any injected additional content that overrides other portions of the content, then method 400 may proceed to step 412. Otherwise, if the client determines that the content does include injected additional content that overrides other portions of the content, then method 400 may proceed to step 414.

At step 412, the client may execute the content as is. After completion of step 412, method 400 may end.

At step 414, if the content includes an action in which the injected additional content is interested (e.g., a JavaScript evaluation function), the execution of such action by the client may be intercepted, and the client may, in accordance with the injected additional content, communicate parameters associated with execution of the action to an inspection service for inspection of the action. Such inspection service may execute locally on the security device or remotely on a cloud-based inspection service (e.g., coupled to external network 202). During inspection of the action by the inspection service, the client may execute the action while the inspection service inspects the action.

At step 416, the client may receive a response from the inspection service and determine from the response whether the action was determined by the inspection service to be malicious. If the action was determined to be malicious, method 400 may proceed to step 418. Otherwise, if the action was determined to not be malicious, method 400 may proceed to step 420.

At step 418, the client may display a user warning that the action, which was executed, has malicious content. After completion of step 418, method 400 may end.

At step 420, the client may allow the action to execute without warning. After completion of step 420, method 400 may end.

Is noted that in execution of method 400, as the client parses the content and removes obfuscation layers of the content, the remainder of the content may have additional content injected as in step 406, such that each obfuscation layer may be appropriately analyzed and examined for malicious content until the whole content of the network traffic has been processed.

Although FIG. 4 discloses a particular number of steps to be taken with respect to method 400, method 400 may be executed with greater or fewer steps than those depicted in FIG. 4. In addition, although FIG. 4 discloses a certain order of steps to be taken with respect to method 400, the steps comprising method 400 may be completed in any suitable order.

Method 400 may be implemented using CPU 102, security management system 118 executing thereon, and/or any other system operable to implement method 400. In certain embodiments, method 400 may be implemented partially or fully in software and/or firmware embodied in computer-readable media.

Although the foregoing contemplates that security management system 118 resides in security device 220, in some embodiments, security management system 118 may be implemented by a device external to security device 220, including without limitation a device within external network 202. In yet other embodiments, the functionality described above, particularly that of method 300, may be implemented within a client device and/or a cloud-based inspection system.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding this disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A computer-implementable method for managing network communication, comprising:
responsive to receipt of traffic from a server to a client:
parsing content of the traffic; and
injecting additional content into original content of the server response to override an action of the original content, such that when the client executes the content of the traffic the client:
determines whether the content includes additional content that overrides the action of the original content; and
in response to determining that the content includes additional content that overrides the action of the original content, communicates parameters associated with execution of the action to an inspection service to determine if the action is malicious.

2. The method of claim 1, wherein the inspection service executes locally on a security device that performs the steps of parsing content of the traffic and injecting additional content into original content of the server response.

3. The method of claim 1, wherein the inspection service executes remotely from a security device that performs the steps of parsing content of the traffic and injecting additional content into original content of the server response.

4. The method of claim 1, such that the client further, in response to determining that the content includes additional content that overrides the action of the original content, executes the action during inspection of the action by the inspection service.

5. The method of claim 4, such that the client further:
receives an indication from the inspection service regarding whether the action is malicious; and
if the indication from the inspection service indicates the action is malicious, communicates a warning to the user indicating that the action is malicious.

6. The method of claim 1, such that the client further, in response to determining that the content includes additional content that overrides the action of the original content, delays the action during inspection of the action by the inspection service.

7. The method of claim 6, such that the client further:
receives an indication from the inspection service regarding whether the action is malicious; and
if the indication from the inspection service indicates the action is malicious, blocks execution of the action.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
responsive to receipt of traffic from a server to a client:
parsing content of the traffic; and
injecting additional content into original content of the server response to override an action of the original content, such that when the client executes the content of the traffic the client:
determines whether the content includes additional content that overrides the action of the original content; and
in response to determining that the content includes additional content that overrides the action of the original content, communicates parameters associated with execution of the action to an inspection service to determine if the action is malicious.

9. The system of claim 8, wherein the inspection service executes locally on a security device that performs the steps of parsing content of the traffic and injecting additional content into original content of the server response.

10. The system of claim 8, wherein the inspection service executes remotely from a security device that performs the steps of parsing content of the traffic and injecting additional content into original content of the server response.

11. The system of claim 8, such that the client further, in response to determining that the content includes additional content that overrides the action of the original content, executes the action during inspection of the action by the inspection service.

12. The system of claim 11, such that the client further:
receives an indication from the inspection service regarding whether the action is malicious; and
if the indication from the inspection service indicates the action is malicious, communicates a warning to the user indicating that the action is malicious.

13. The system of claim 8, such that the client further, in response to determining that the content includes additional content that overrides the action of the original content, delays the action during inspection of the action by the inspection service.

14. The system of claim 13, such that the client further:
receives an indication from the inspection service regarding whether the action is malicious; and
if the indication from the inspection service indicates the action is malicious, blocks execution of the action.

15. A non-transitory, computer-readable storage medium embodying computer program code, the computer program code comprising computer executable instructions configured for:
responsive to receipt of traffic from a server to a client:
parsing content of the traffic; and
injecting additional content into original content of the server response to override an action of the original content, such that when the client executes the content of the traffic the client:
determines whether the content includes additional content that overrides the action of the original content; and
in response to determining that the content includes additional content that overrides the action of the original content, communicates parameters associated with execution of the action to an inspection service to determine if the action is malicious.

16. The storage medium of claim 15, wherein the inspection service executes locally on a security device that performs the steps of parsing content of the traffic and injecting additional content into original content of the server response.

17. The storage medium of claim 15, wherein the inspection service executes remotely from a security device that performs the steps of parsing content of the traffic and injecting additional content into original content of the server response.

18. The storage medium of claim 15, such that the client further, in response to determining that the content includes additional content that overrides the action of the original content, executes the action during inspection of the action by the inspection service.

19. The storage medium of claim 18, such that the client further:
receives an indication from the inspection service regarding whether the action is malicious; and
if the indication from the inspection service indicates the action is malicious, communicates a warning to the user indicating that the action is malicious.

20. The storage medium of claim 15, such that the client further, in response to determining that the content includes additional content that overrides the action of the original content, delays the action during inspection of the action by the inspection service.

21. The storage medium of claim 20, such that the client further:
receives an indication from the inspection service regarding whether the action is malicious; and
if the indication from the inspection service indicates the action is malicious, blocks execution of the action.
